(19) United States
(12) Patent Application Publication
(10) Pub. No.: US 2013/0109024 A1
(43) Pub. Date: May 2, 2013

(54) OBTAINING ANALYTES FROM A TISSUE SPECIMEN

(71) Applicants: Sridharan Rajagopalan, Houston, TX (US); William G. McLucas, Houston, TX (US)

(72) Inventors: Sridharan Rajagopalan, Houston, TX (US); William G. McLucas, Houston, TX (US)

(21) Appl. No.: 13/699,021

(22) PCT Filed: May 27, 2011
(86) PCT No.: PCT/US11/38306

§ 371 Date: Nov. 20, 2012

(51) Int. Cl. C12Q 1/68; G01N 1/28; G01N 33/53

(52) U.S. Cl. CPC G01N 1/28
USPC 435/6.12; 435/7.92

(57) ABSTRACT

A method of obtaining for analysis one or more analytes of diagnostic interest from a tissue specimen having an identified area of diagnostic interest in a two-dimensional spatial location, comprising contacting the identified area of diagnostic interest with a contact medium, effecting at least partial transfer of the one or more analytes from the area of diagnostic interest to the contact medium, and removing the contact medium from the specimen for analysis for the one or more analytes of diagnostic interest.

### STATEMENT REGARDING FEDERALLY SPONSORED RESEARCH AND DEVELOPMENT

Not Applicable

### BACKGROUND OF THE DISCLOSURE

1. Field of Disclosure

This invention relates to bioassays and molecular diagnostics in which analyte molecules are recovered from a tissue specimen.

2. Background

Cancer is a class of diseases in which a group of cells divide beyond normal limits, intrude on and destroy adjacent tissues, and spread to other locations in the body via lymph or blood. Cancers are caused by abnormalities in the genetic material of the transformed cells of the host's genome. While cancer may be suspected from medical tests and imaging, definitive diagnosis often currently requires a microscopic histology examination of a biopsy specimen. For this, a sample of tissue may be removed with preservation of the histological architecture of the tissue's cells (incisional or core biopsy) or a sample of tissue or fluid comprising cells or cell clusters may be removed with a needle without preserving the histological architecture of the tissue cells (a needle aspiration biopsy). Incisional or core biopsies are solids. Cells from needle aspirations may be cultured for cell growth and the colonized growth treated as a solid. In addition, a surgeon may have resected tissue already diagnosed as cancerous and specimens of the resected tissue may be microscopically examined.

At present, two procedures are generally used in preparing solid specimens of tissue for microscopic examination. In one procedure a biopsy specimen is quick frozen, cut and mounted on a slide in an elapsed time of about 15 minutes for a rapid histological diagnosis of the specimen, and is typically employed in situations where a diagnosis is necessary while a patient is on an operating table to examine the surgical margins of a resection to determine whether the margins are clear of cancerous cells and if not to advise that further surgery is necessary.

For more definitive morphological examination and archiving, solid specimens of tissue are treated with a fixative, typically a neutral buffered formalin, to stop cellular processes and tissue autolysis. The specimens are then transferred to a cassette container to allow reagents to freely act on the tissue inside. The cassette is immersed in multiple baths of progressively more concentrated ethanol, to dehydrate the tissue, followed by a toluene or xylene bath, and finally by a bath in hot paraffin. During this 12 to 16 hour process, paraffin will replace the water in the tissue, turning soft, moist tissues into a sample miscible with paraffin. The processed tissue is then taken out of the cassette and placed in a mold. Paraffin is added to the mold to embed the tissue in a paraffin block about the size of a postage stamp. For preservation of tissue samples, this method of formalin fixation followed by embedding in paraffin has been the method of choice for decades, mostly because this treatment maintains morphological features of the original tissue particularly well. Formalin fixed paraffin embedded tissue is conventionally called a “FFPE” tissue, and the paraffin block is called a “FFPE” block.

For histological examination, serial thin sections (5-10 microns, thinner than the average cell) are sliced from the FFPE block. A block 1 mm deep affords 200 slices 5 microns thick, although ordinarily less than 50 slices are taken, leaving the remainder of the block for archiving. The thin sections are floated on water to enable them to be transferred to glass slides, and the sections are securely mounted on the slides when they are heated. The slides are then deparaffinized and hydrated (by sequential baths in xylene, ethanol and water) to expose the tissue, and one or more solutions including reagents such as histochemical or immunological stains for chromogenic or fluorescent visualization, are dropped onto the slide, incubated, and washed off. Finally the sample may be viewed under the microscope. A pathologist examines the slide under a light microscope and looks for any abnormalities in the tissue. The pathologist may image areas of a slide using a digital camera for archiving and may use image editing tools to mark areas of tissue abnormalities. A digital image of the slide may be displayed at a web host to another pathologist for discussion, and interactive collaboration tools may be employed to mark abnormal areas. The pathologist prepares a report that lists any abnormal or important findings, and sends this report to the physician who performed the biopsy. The FFPE block is archived in a biobank in the hospital (or maintained elsewhere by or for the hospital) for retrieval and possible future further slicing of tissue sections and tests on those slices.

In a variation, instead of sequentially sectioning a FFPE, in the tissue microarray technique, a hollow needle is used to remove tissue cores as small as 0.6 mm in diameter from regions of interest in paraffin-embedded tissues such as clinical biopsies or tumor samples. These tissue cores are then inserted in a recipient paraffin block in a precisely spaced array pattern. Sections from this block are cut using a microtome, mounted on a microscope slide and then analyzed by any method of standard histological analysis. The FFPE block is archived for further access.

The histological examination at the tissue level identifies which cells are cancerous but cannot tell what abnormality at a molecular level is responsible for the cancer. There has been significant progress in knowledge of the DNA makeup of humans during the past several decades in which the human genome has successfully been mapped. New techniques such as immunohistochemistry, in situ hybridization, fluorescent in situ hybridization, polymerase chain reaction, reverse transcription, in situ-PCR, laser capture microdissection, complementary DNA, DNA microarrays, miRNA and methylation measurement, protein phosphorylation and acetylation measurement, tissue microarrays and others have been developed and continue to be developed for research and diagnosis of molecular pathology. Many genes and signaling pathways that control cell proliferation, death and differentiation, as well as genomic integrity, have been measured by these and other techniques, revealing many new potentially important cancer genes. The determination of particular DNA mutations producing cancerous cells has led to molecular development of targeted therapy drugs that act specifically on detectable molecular abnormalities in certain tumors while at the same time minimizing damage to normal cells.

It is currently thought that over 300-600 genes are involved in the development or origin of cancers and its progress. Currently there are only about 30-40 genes identified for DNA testing to determine what molecular the abnormality is and to what it will it respond. Of the 30-40 genes for which tests can be conducted, only about 8 to 10 are tested relatively routinely. If a pathologist determines from histological examination (by conventional sectioning or tissue microarray) that cells are cancerous, a protocol under which the pathologist operates may require DNA testing of the cells, with the results to be furnished later to the oncologist as a supplement to the original report. Ordinarily the FFPE block containing the examined tissues to be DNA tested is shipped from the pathology department's biobank to an outside professional DNA testing laboratory, which often is not in the same city or state. The DNA laboratory removes a slice from the received FFPE block, deparaffinizes it and exposes it to extraction to dissolve the nucleic acids in cells in the slice into a solution from which PCR amplification and quantification and/or other molecular biology analysis is performed to identify the presence and amount of specific molecular markers. A problem with this use of the FFPE tissue block is that normal cells in the FFPE tissue slice analyzed by the DNA lab adulterate the DNA (or other analyte) from abnormal cells in the tissue slice.

Upon completion of DNA testing, the FFPE block is shipped back to the ordering oncologist/pathologist. This need to ship the FFPE block to and from a remote location for DNA testing not only eliminates the ability of the patient's oncologist and pathology lab to conduct other tests on the tissue sample while the FFPE block is absent from the hospital's biobank, it also poses risk of loss or destruction of the block in transit or due to mishandling errors. Apart from liability issues from loss, the only solution for a lost or destroyed FFPE block is to subject the patient to another biopsy—if any of the tissue of interest remains in the patient.

An alternative to shipping the entire FFPE block is to manually scrape a little bit of cells off the glass slide (in the general area of the slide where cancer cells have been identified by the pathologist) into a test tube and send the test tube to the DNA testing lab. Another alternative is to slice sections from the FFPE block, mount the sliced sections on slides, and send the slides to the remote DNA lab for extraction of material from the slide. A problem with the former alternative is leakage and ruination of sample before it arrives at its destination. A problem with the latter alterative is dilution of the abnormal DNA in cancer cells with normal DNA in non-cancerous cells on the slide (adulteration).

The problem of getting samples from hospital biobanks to remote DNA testing labs is not restricted to testing done for patients. The biobanks of FFPE comprise a prime source of material for molecular genetic studies leading to the development of new drugs targeting specific cancer cell DNA mutations and abnormalities. To date, cancer gene sequencing programs have essentially relied on DNA isolated from fresh frozen tissues, access to which can be limited. About 500,000 biopsies are performed daily in the United States resulting in nearly that many FFPE blocks being archived daily, leading to vast amounts of biobanked tissues accumulating yearly (130 million FFPE blocks per annum by extension of 500,000 per weekday). Cumulatively reaching back decades (a total of 1.3 billion per decade, by the same calculation), these archival FFPE tissues are of significant value for genetic and drug studies because they frequently are the only sources of tissue available from large patient cohorts with comprehensive clinical data and long-term follow-up (spanning decades in some cases). But the same problems of removal from the biobanks and preserving the security of the FFPE blocks exists for genetic and drug studies as with individual patient testing for oncologists, as does the problem of adulteration of DNA in cancerous cells with DNA in normal cells.

There is therefore a felt need for alternatives to the present ways of handling FFPE blocks or sections of the block for detecting and/or quantitating biomarkers, especially DNA and modified DNA, mRNA and miRNA, microbial and oncogene nucleic acids, proteins, and modified (e.g., phosphorylated and acetylated) proteins, in particular portions of a biopsy specimen. The needs of society for such assays are not well met by any currently available method for using FFPE blocks as a source of tissue samples, yet there is continuing rapid development in the detection of biological molecules and biomarkers. With the speed of growth in gene testing technology, augmented by robotic testing and ever increasing computational powers of computers, it is thought that in the near future it will be possible to test 300-600 or more genes for cancer relatively routinely rather than the 30-40 able to be tested now. Thus the scope and size of the problem of handling FFPE tissues just for genes involved in the development of cancers alone looms ever larger without a practical and better alterative to the present methods.

While the nature of the problem of handling FFPE tissues for genetic analysis is described above in terms of cancer, the use of FFPE samples for gene testing and drug development is not restricted to cancer, but has reach throughout the spectrum of medicine, especially where histology and genetics meet. With gene and drug testing that makes use of the vast amount of DNA material in FFPE biobanks, certain gene sequences gone wrong will be identified to predispose one to cardiovascular disease, certain will be identified to arthritis, some will be linked to a propensity to develop pneumonia often, and so forth. The questions will be what gene or what gene sequences in a patient's genome have mutated from the normal, what physiological consequences resulted, and what drugs can be developed to counter the adverse effects. There is also interest in the presence of non-human (RNA or DNA) genomes in human specimens, as from infectious diseases. Viruses are an established cause of some cancers; for example, human papillomaviruses are an established cause of cancers of the cervix. In all these instances, for gene testing to be performed without the described risks of loss and damage to the FFPE block and the adulteration of DNA from cells histologically identifiable as diseased with DNA from normal cells, alternatives to today's usage of primary FFPE tissue of the patient are needed.

The embodiments of the present invention address these felt and growing needs.

### BRIEF DESCRIPTION OF THE DRAWINGS

In the following detailed description of exemplary embodiments, reference is made to the accompanying drawings, which form a part hereof and in which are shown by way of illustration examples of an exemplary embodiment in which the invention may be practiced. In the drawings and descriptions, like parts are marked throughout the specification and drawings with the same reference numerals, respectively. The drawings are schematic and not to scale. Certain features are shown exaggerated in scale and some details of conventional elements may not be shown in the interest of clarity and conciseness.

FIG. 1A is a schematic top view of a FFPE tissue specimen section.

FIG. 1B is a schematic top view of a FFPE tissue specimen section on a first receiving surface.

FIG. 1C is a schematic top view of a FFPE tissue specimen section on a second receiving surface.

FIG. 2A is a schematic side view of a FFPE tissue specimen on a bar coded support.

FIG. 2B is a schematic side view of a diagnostically interesting portion of a section of a FFPE tissue specimen removed from the bar coded support of FIG. 2A.

FIG. 2C is a schematic side view of the diagnostically interesting portion of a section of a FFPE tissue specimen applied to a bar coded receiving surface

FIG. 3 is a top view of the diagnostically interesting portion of a section of a FFPE tissue specimen applied to the bar coded receiving surface of FIG. 2C.

FIG. 4 is a schematic side view of the diagnostically interesting portion of a section of a FFPE tissue specimen applied to a bar coded receiving surface in juxtaposition with a capture medium for transfer of diagnostic molecules of interest to the capture medium.

### DETAILED DESCRIPTION OF EMBODIMENTS

The present invention provides a methodology for bioassays and molecular diagnostics in which specific molecules and/or biomarkers are detected with location selectivity. The location of interest can be chosen based on the results of visual examination, to enrich the signal from particular types of tissues, structures or cells, to minimize signal from other types of tissues or cells, or on the basis of the results of imaging, or other diagnostics or assays.

In accordance with an embodiment of this invention, a tissue specimen is optionally pre-treated for identification and/or to preserve or enhance accessibility of analyte molecules of interest, optionally the spatial location(s) of one or more areas of diagnostic interest in the tissue specimen are identified by one of multiple methods, and molecules are transferred from a portion of the specimen to a contact medium, from which the contact medium may be removed for analysis of one or more analytes of interest.

In an embodiment, a method of obtaining for analysis one or more analytes of diagnostic interest from a tissue specimen having an identified area of diagnostic interest in a two-dimensional spatial location, comprises contacting the identified area of diagnostic interest with a contact medium and effecting at least partial transfer of the one or more analytes from the area of diagnostic interest to the contact medium, and removing the contact medium from the specimen for analysis for the one or more analytes of diagnostic interest. The contact medium may be a liquid medium or a solid phase medium. The liquid medium may be totally liquid, a suspension, an emulsion or a gel, and is further detailed below. The solid phase medium is further detailed below. In an embodiment, the solid phase medium is contacted with the identified area of diagnostic interest in a two-dimensional spatial location in a manner to mirror the location of that area on the solid phase medium

In an embodiment, the tissue specimen may comprise fresh tissue, frozen tissue, neutral formalin-treated tissue, formalin fixed paraffin embedded tissue block, and ethanol-fixed paraffin-embedded tissue block.

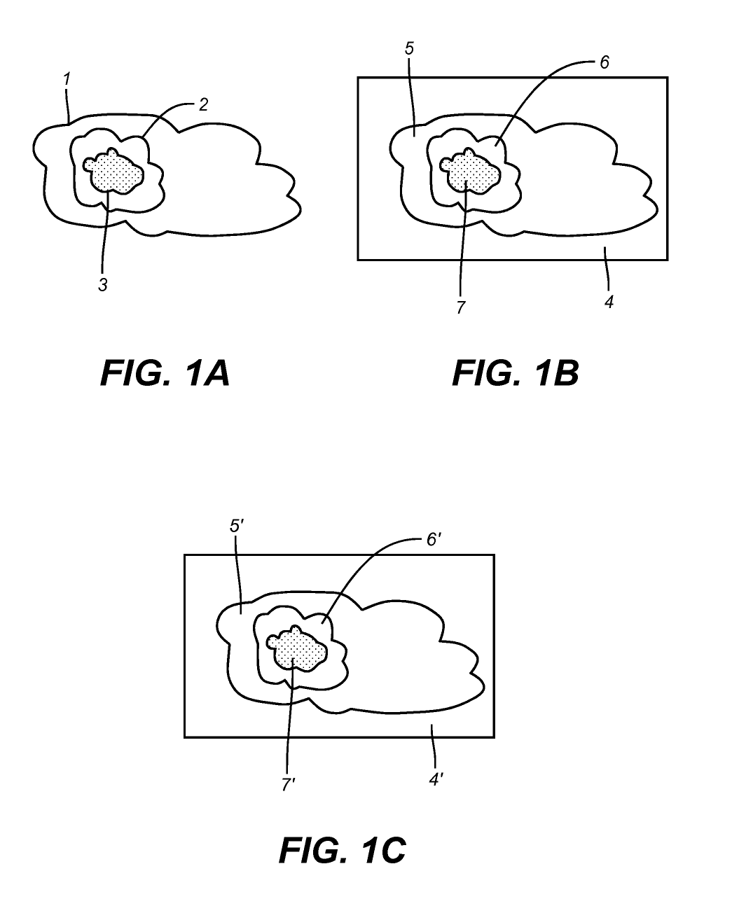

In an embodiment the method is advantageously applied to formalin fixed paraffin embedded tissue in FFPE blocks, and is conceptually illustrated in FIGS. 1A-1C of the drawings. Referring to FIG. 1A, a FFPE block 1 contains a tissue specimen 2 having an area 3 of diagnostic interest. Referring to FIG. 1B, FFPE block 1 is contacted with a solid phase receiving surface 4 under conditions under which paraffin 5, molecules 6 from the tissue specimen 2 and/or molecules 7 from the diagnostically interesting portion 3 of the tissue specimen are transferred to receiving surface 4. The FFPE block can be contacted with an additional receiving surface 4′, to which can be transferred some additional paraffin 5′, molecules 6′ from the tissue specimen 2 and molecules 7′ from the diagnostically interesting portion 3 of the tissue specimen 2.

In an embodiment the method further comprises identifying and documenting the two-dimensional spatial location of said area of diagnostic interest in the source before contacting the source with the solid phase medium and effecting transfer of the analyte.

In one embodiment, the method obtains one or more analytes of diagnostic interest from a tissue specimen for analysis. This method comprises (a) slicing a first tissue section from a tissue specimen, (b) documenting the spatial location(s) of one or more areas of diagnostic interest in the first tissue section, and (c) contacting the tissue specimen with a solid phase medium and effecting transfer of one or more analytes from the one or more areas of diagnostic interest in the tissue specimen to the solid phase medium in a manner that places the analytes at the same relative two dimensional spatial locations of the solid phase medium as the locations of the areas of interest in the tissue specimen.

Transfer is suitably not applied to the entire specimen or the entire material to which molecules of interest are transferred, but rather to sub-portions chosen based on previous assays, imaging, staining, sorting or inspection.

A tissue specimen is optionally pre-treated for identification and/or to preserve or enhance accessibility of molecules of interest, optionally imaged by one of multiple methods, a section of the specimen is prepared, the section is optionally pre-treated for identification and/or to preserve or enhance accessibility of molecules of interest and molecules are transferred from a portion of the section to a location from which they can be detected. Methods to be used, in addition to those described below, are those described above for diagnostics based on direct transfer from a tissue specimen.

Accordingly, in another embodiment for obtaining one or more analytes of diagnostic interest from a tissue specimen for analysis, a method comprises (a) slicing a first tissue section from a tissue specimen, (b) documenting the spatial location(s) of one or more areas of diagnostic interest in the first tissue section, (c) slicing a second tissue section from the tissue specimen in a manner to preserve in the second section the same spatial location(s) of the areas of interest recorded for the first tissue section, and (d) contacting the second tissue section with a solid phase medium and effecting transfer of one or more analytes from the one or more areas of diagnostic interest to the solid phase medium in a manner that places the analytes in or on the solid phase medium at the same two dimensional spatial locations as the locations of the areas of interest in the second tissue section.

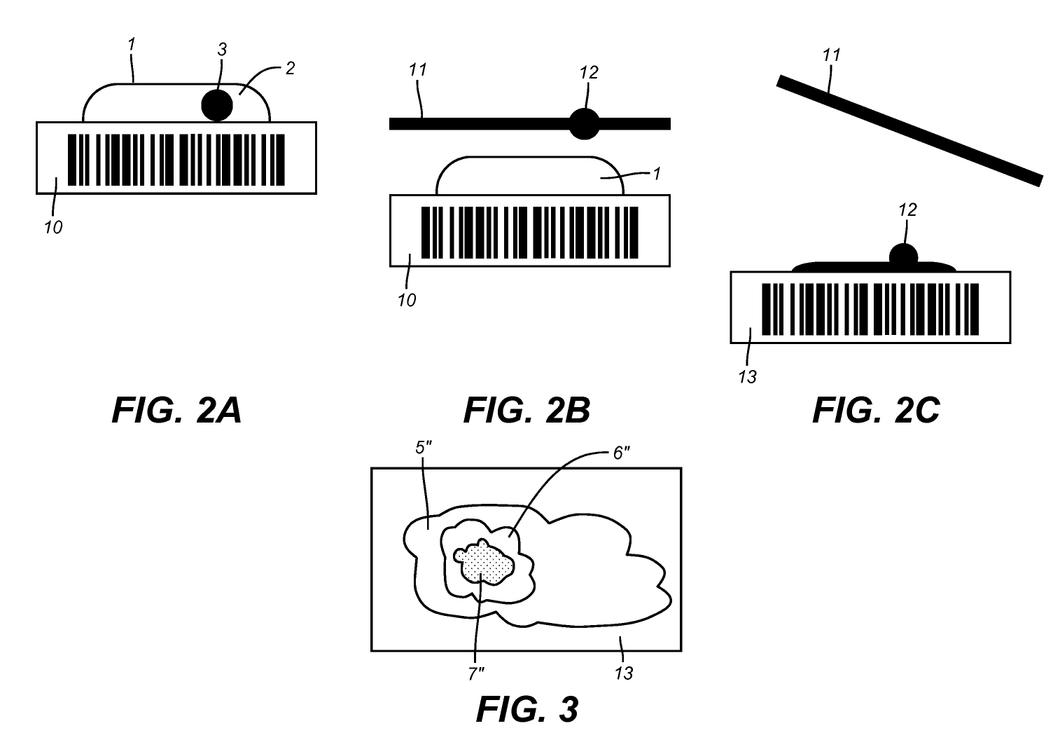

The method is advantageously applied to formalin fixed paraffin embedded tissue in FFPE blocks, and is conceptually illustrated in FIGS. 2A-2C and 3 and FIG. 4 of the drawings. Referring to FIG. 2A, an FFPE block 1 containing a diagnostically interesting portion 3 of an embedded tissue specimen 2 is supported on a bar-coded support 10. FIG. 2B represents FFPE block 1 having been sectioned to produce a thin slice or section 11 containing diagnostically-informative molecules 12, leaving behind the remainder of the FFPE block 1 on the bar-coded support 10. FIG. 2C represents slice 11 having been pressed against a bar-coded receiving surface 13 to transfer molecules 12 from slice 11 of FFPE block 1. Referring to FIG. 3, as seen face on, the receiving surface 13 can support a small amount of paraffin 5″, molecules 6″ from the tissue specimen 2 and molecules 7″ from the diagnostically interesting portion 3 of the tissue specimen 2 in FFPE block 1.

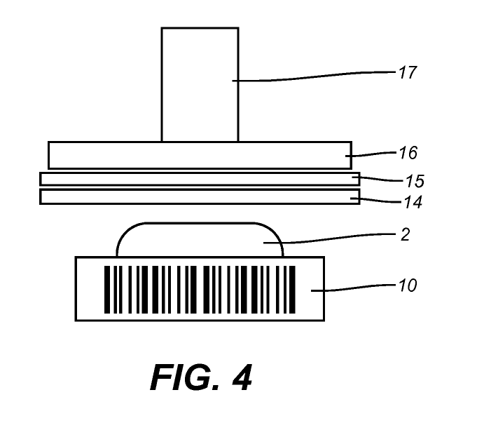

Referring to FIG. 4, a FFPE tissue section 2 is supported on an electrically-conductive, bar-coded support 10, and brought into apposition with a conductive, non-adsorptive separator 14 and a conductive adsorptive receiving member 15, supported on an electrically-conductive support 16 by a device 17 capable both of holding the other components together and of applying an electrical voltage. The application of voltage drives the transfer of nucleic acids from the section 2 to the receiving member 15.

In an embodiment of the identification aspect of foregoing methods, identification comprises at least one of human or machine inspection of the source and recordation of the two-dimensional spatial location of the area of diagnostic interest in the source. The recordation suitably comprises an image. The inspection may be human by view by microscope and the recordation may comprise making a photographic image of the field of view of the microscope in which the area of diagnostic interest in the source is viewed. The inspection may be by machine imaging by one or more of X-ray, infrared, fluorescence, ultrasound, absorbance, scattering, optoacoustic imaging, computed tomography, optical coherence tomography, magnetic resonance imaging, and spatially-resolved chemical analysis. Both human and machine inspection may be conducted and the results of the inspection combined to define the situs of the area of diagnostic interest in the source. Two machine imaging modalities may be used in which data results from use of the two modalities are combined mathematically to define the situs of the area of diagnostic interest in the source.

In an embodiment, the source biological source may be pre-treated by removing layers of the source to a depth predetermined by definition of the situs to expose the situs. Removing of portions of the source may be by a scanning probe, blade, jet, energy beam, fluid or gas flow, sonicator, enzyme or chemical action, or vacuum to a depth predetermined by definition of the situs to expose the situs.

In an embodiment, the source is prepared for contacting with said solid phase medium by acid, enzyme action, heat, surfactant, or disrupting mechanical force.

In an embodiment, the solid phase medium is a single membrane.

In an embodiment, the solid phase medium is separated from the source by a liquid or gel.

In an embodiment, the solid phase medium comprises an adsorbent.

In an embodiment, the solid phase medium comprises a charged surface.

In an embodiment, the solid phase medium is non-porous.

In an embodiment, the solid phase medium is not penetrated from one face to the other by pores covering more than 2% of its area.

In an embodiment, the solid phase medium comprises a marked dimension by which coordinates of an area of interest can be described.

In an embodiment, the solid phase medium is formatted as a grid.

In an embodiment, the solid phase medium has the form of a roll, deck or strip.

In an embodiment, the solid phase medium comprises more than one composition, and the step of contacting further comprises sequentially contacting the source area of diagnostic interest with the solid phase medium of more than one composition.

In an embodiment in which the solid phase medium comprises more than one composition, and the step of contacting further comprises sequentially contacting the source area of diagnostic interest with the solid phase medium of more than one composition, (a) a first surface of a contact medium is moved into opposition with a surface of the source area of diagnostic interest, (b) the first surface is moved into contact with the surface of the source, (c) transfer is effected, (d) the first surface is moved away from the source, (d) a second surface of the contact medium is positioned opposite the surface of the source area, and steps b-d are repeated for the second surface.

In an embodiment in which the solid phase medium comprises more than one composition, the second surface comprises a composition different from the first surface.

In an embodiment, the molecules of interest are transferred under the influence of a temperature or voltage gradient.

In an embodiment, the molecules of interest are transferred under the influence of a liquid flow driven by a pressure difference or by capillarity.

In another embodiment, a method is one of detecting an analyte from a tissue specimen. The method comprises (a) receiving a solid phase medium or a shape supported liquid medium containing one or more analytes in a two dimensional spatial area of interest mirroring an identified two-dimensional spatial area of interest in the tissue specimen from which the one or more analytes were transferred, (b) identifying the location of the two dimensional spatial area of interest of the solid phase medium, (c) separating one or more analytes in the area of interest of part or all of the received solid phase medium into a liquid, and (d) analyzing the liquid for the one or more analytes.

The latter embodiment may be combined with an embodiment of one of the foregoing methods. Thus in one combination of embodiments, the method comprises (a) slicing a first tissue section from a tissue specimen, (b) documenting the spatial location(s) of one or more areas of diagnostic interest in the first tissue section, and (c) contacting the tissue specimen with a solid phase medium and effecting transfer of one or more analytes from the one or more areas of diagnostic interest in the tissue specimen to the solid phase medium in a manner that places the analytes at the same two dimensional spatial locations of the solid phase medium as the locations of the areas of interest in the tissue specimen, (d) identifying the areas of interest of the solid phase medium by reference to the identification of locations made in action (b), (e) isolating the analytes in said identified area of interest from analytes in the remainder of the solid phase medium, and (f) analyzing the isolated molecules of interest for an analyte.

In another combination embodiment the method comprises (a) slicing a first tissue section from a tissue specimen, (b) documenting the spatial location(s) of one or more areas of diagnostic interest in the first tissue section, (c) slicing a second tissue section from the tissue specimen in a manner to preserve in the second section the same spatial location(s) of the areas of interest recorded for the first tissue section, and (d) contacting the second tissue section with a solid phase medium and effecting transfer of one or more analytes from the one or more areas of diagnostic interest to the solid phase medium in a manner that places the analytes in or on the solid phase medium at the same two dimensional spatial locations as the locations of the areas of interest in the second tissue section, (e) identifying the areas of interest of the solid phase medium by reference to the identification of locations made in action (b), (f) isolating the analytes in the identified area of interest from analytes in the remainder of the solid phase medium, and (g) analyzing the isolated molecules of interest for a biomarker.

In one embodiment, the step of isolating comprises physically separating a portion of the solid phase medium from the rest of the solid phase medium, said portion corresponding to the two dimensional spatial locations of the solid phase medium corresponding to the identified locations of the areas of interest in the tissue specimen.

In another embodiment, the step of isolating comprises eluting the two dimensional spatial locations of the solid phase medium corresponding to the identified locations of the areas of interest in the tissue specimen.

In an embodiment, the analytes of diagnostic interest are one or more of genomic DNA, methylated DNA, specific methylated DNA sequences, messenger RNA, fragmented DNA, fragmented RNA, fragmented mRNA, mitochondrial DNA, viral RNA, microRNA, lipids, carbohydrates, in situ PCR product, polyA mRNA, RNA/DNA hybrid, protein, glycoprotein, lipoprotein, phosphoprotein, specific phosphorylated or acetylated variant of a protein, or viral coat proteins.

In an embodiment, the step of analyzing comprises one or more of PCR, qPCR, RT-PCR, NASBA, LAMP, RCA, immunoassay, immunoPCR, enzyme activity assay, staining, imaging, WGA, in situ PCR, in situ WGA, polony formation, sequencing, single-molecule sequencing, nanopore analysis, nanopore sequencing, single-molecule imaging, DNA ball formation, electrophoresis, MEMS electrophoresis, mass spectrometry, GC, LC, LC-MS, proximity ligation assay, electrochemical detection, plasmon resonance, FRET, electrochemiluminescence ELISA, and chemiluminescence ELISA.

### Elements of Embodiments

The methods described above are further described by amplification of individual elements of embodiments of the methods,

### Analyte Molecules of Diagnostic Interest

Analyte molecules of diagnostic interest from tissue specimens of interest—and for which elements of specimen preparation, solid phase media, driving forces for effecting transfer of the analyte molecules to a solid phase medium, recovery from a solid phase medium and detection, are selected and directed—comprise genomic DNA, methylated DNA, specific methylated DNA sequences, messenger RNA, fragmented DNA, fragmented RNA, fragmented mRNA, mitochondrial DNA, viral RNA, microRNA, in situ PCR product, polyA mRNA, RNA/DNA hybrid, pathogen DNA, pathogen RNA, metabolite, metabolic intermediate, lipid, carbohydrate, protein, glycoprotein, lipoprotein, phosphoprotein, specific phosphorylated or acetylated variant of a protein, or viral coat proteins, in or isolated from cells, body fluids, or tissues.

### Tissue Specimens

Tissue specimens of interest comprise punch biopsy specimens, needle biopsy specimens, fresh tissues, tissue cultures, frozen tissue specimen, neutral formalin-treated tissues, organs, organelles, formalin fixed paraffin embedded tissue block (FFPE), ethanol-fixed paraffin-embedded tissue block.

### Identification

Identifying comprises marking, photographing, scanning, and otherwise imaging to record the spatial location(s) of one or more areas of diagnostic interest in the first tissue specimen. Imaging may be created by a digital camera or other CCD device, and the image may be marked using photo-editing or other tools to identify the areas of diagnostic interest. Imaging may be created by one or more of X-ray, infra-red, ultrasound, magnetic resonance imaging, computed axial tomography, optical coherence tomography, mechanical property profiling, scanning-inlet GC, scanning inlet LC, and scanning inlet chromatography-MS (e.g., for metabolic intermediate concentration profiling), computationally processed to identify likely tumor locations.

### Tissue Specimen Pretreatment

In an embodiment, the surface area of the tissue specimen or subsection is treated before contact with a contact medium by means comprising acid, enzyme action, chemical action, heat, surfactant, or disrupting mechanical force. Elements of specimen preparation, which can be applied to the whole specimen or only a portion thereof, to fresh or frozen specimens, and to FFPE or similarly preserved and embedded specimens, comprise

a. staining, for non-limiting example: H&E staining;

b. enzymes, singly or mixtures, including, for non-limiting example: RNAse, DNAse, nuclease, carbohydrase, protease, lipase;

c. enzyme inhibitors, for non-limiting example: nuclease inhibitor, RNAse inhibitor, DNAse inhibitor, protease inhibitor (including, without limitation, phenylmethylsulfonyl fluoride), phosphatase inhibitor, glycosidase inhibitor, prior to preservation or embedding;

d. denaturants, including, for non-limiting examples: beta-mercaptoethanol, dithiothreitol, tris(2-carboxyethyl)phosphine, alkali, acids, or guanidine isothiocyanate;

e. extractants, including, for non-limiting example: xylene or other hydrophobic or non-polar solvent for deparaffinization; and solvation and surfactant elements, including, for non-limiting example: EDTA, limonene, surfactant, ester solvent, ester solvent followed by lipase, supercritical fluid solvent, liquid carbon dioxide solvent, a solution with pH below 5.0, a solution with pH above 9.0, a water/organic mixture, DMSO, water heated above 70° C., locally-applied extractants, and solvents or extractants supported in a porous matrix such as cloth, paper, wick or sponge;

f. mechanical disruption, including, for non-limiting example: maceration, scoring, indenting, abrasion, damage by cutter plotter, sonication, sandblasting;

g. thermal treatment, including, without limitation: heating, heating by hot liquid applied, heating by chemical reaction, or heating by strong illumination, 95-GHz millimeter wave irradiation, or microwave treatment;

h. liquid cleansing, including, without limitation: washing or leaching;

i. electropotential modification, including without limitation: oxidation, reduction or electroporation;

j. biomolecular modification, including, without limitation: in situ PCR, in situ whole-genome amplification, or restriction endonuclease digestion;

k. sorption, including, without limitation: blotting at elevated temperature or sponging; and

l. de-surfacing, including, without limitation: uncovering or sectioning.

The foregoing elements of treatment comprise treatments that can be applied (a) to fresh or frozen tissue before preservation, (b) after preservation and before embedding, and (c) after embedding.

The treatments which can be applied before preservation comprise:

a. staining, for non-limiting example: H&E staining;

b. enzymes, singly or mixtures, including, for non-limiting example: RNAse, DNAse, nuclease, carbohydrase, protease, lipase;

c. enzyme inhibitors, for non-limiting example: nuclease inhibitor, RNAse inhibitor, DNAse inhibitor, protease inhibitor (including, without limitation, phenylmethylsulfonyl fluoride), phosphatase inhibitor, glycosidase inhibitor, prior to preservation or embedding;

d. denaturants, including, for non-limiting examples: beta-mercaptoethanol, dithiothreitol, tris(2-carboxyethyl)phosphine, or guanidine isothiocyanate;

e. solvation and surfactant elements, including, for non-limiting example: EDTA, limonene, surfactant, ester solvent, ester solvent followed by lipase, supercritical fluid solvent, liquid carbon dioxide solvent, a solution with pH below 5.0, a solution with pH above 9.0, a water/organic mixture, DMSO, water heated above 70° C., locally-applied extractants;

f. mechanical disruption, including, for non-limiting example: maceration, scoring, indenting, abrasion, damage by cutter plotter, sonication, sandblasting;

g. thermal treatment, including, without limitation: heating, hearing by hot liquid applied, heating by chemical reaction, or heating by strong illumination, 95-GHz millimeter irradiation, or microwave treatment;

h. liquid cleansing, including, without limitation: washing or leaching;

i. electropotential modification, including without limitation: oxidation, reduction or electroporation;

j. biomolecular modification, including, without limitation: in situ PCR, in situ whole-genome amplification, or restriction endonuclease digestion;

k. sorption, including, without limitation: blotting at elevated temperature or sponging; and

l. de-surfacing, including, without limitation: uncovering or sectioning.

The treatments that can be applied after preservation and before embedding comprise:

a. staining, for non-limiting example: H&E staining;

b. enzymes, singly or mixtures, including, for non-limiting example: RNAse, DNAse, nuclease, carbohydrase, protease, lipase;

c. enzyme inhibitors, for non-limiting example: nuclease inhibitor, RNAse inhibitor, DNAse inhibitor, protease inhibitor (including, without limitation, phenylmethylsulfonyl fluoride), phosphatase inhibitor, glycosidase inhibitor, prior to preservation or embedding;

d. denaturants, including, for non-limiting examples: beta-mercaptoethanol, dithiothreitol, tris(2-carboxyethyl)phosphine, or guanidine isothiocyanate;

e. extractants, including, for non-limiting example: xylene or other hydrophobic or non-polar solvent for deparaffinization; and solvation and surfactant elements, including, for non-limiting example: EDTA, limonene, surfactant, ester solvent, ester solvent followed by lipase, supercritical fluid solvent, liquid carbon dioxide solvent, a solution with pH below 5.0, a solution with pH above 9.0, a water/organic mixture, DMSO, water heated above 70° C., locally-applied extractants;

f. mechanical disruption, including, for non-limiting example: maceration, scoring, indenting, abrasion, damage by cutter plotter, sonication, sandblasting;

g. thermal treatment, including, without limitation: heating, heating by hot liquid applied, heating by chemical reaction, or heating by illumination, or microwave treatment;

h. liquid cleansing, including, without limitation: washing or leaching;

i. electropotential modification, including without limitation: oxidation, reduction or electroporation;

j. biomolecular modification, including, without limitation: in situ PCR, in situ whole-genome amplification, or restriction endonuclease digestion;

k. sorption, including, without limitation: blotting at elevated temperature or sponging; and

l. de-surfacing, including, without limitation: uncovering or sectioning.

The treatments that can be applied after embedding include:

a. extractants, including, for non-limiting example: xylene or other hydrophobic or non-polar solvent for deparaffinization, solvents in porous matrices such as paper, cloth or sponge, solvent mixtures, limonene, and alcohols; and solvation and surfactant elements, including, for non-limiting example: EDTA, limonene, surfactant, ester solvent, ester solvent followed by lipase, supercritical fluid solvent, liquid carbon dioxide solvent, a solution with pH below 5.0, a solution with pH above 9.0, a water/organic mixture, DMSO, water heated above 70° C., locally-applied extractants;

b. mechanical disruption, including, for non-limiting example: maceration, scoring, indenting, abrasion, compression, damage by cutter plotter, sonication, sandblasting;

c. thermal treatment, including, without limitation: heating, heating by hot liquid applied, heating by chemical reaction, or heating by illumination, 95-GHz millimeter wave exposure, or microwave treatment;

d. liquid cleansing, including, without limitation: washing or leaching;

e. sorption, including, without limitation: blotting at elevated temperature or sponging; and

f. de-surfacing, including, without limitation: uncovering or sectioning.

Specimen preparation may include repeated sectioning based on the results of staining, scanning, or imaging, optionally under automatic control.

### Transfer of Analytes

Transfer of analytes from the tissue specimen may be accomplished by a relative-location-preserving recovery, a recovery method with limited point-spread function width, blotting, electroblotting, dielectrophoresis, pulsed-field electrophoresis, extraction, wicking, pipetting, flow, capillary wicking, liquid expression, diffusion, suction, surfactant extraction, reverse micellar extraction, denaturing extraction, ultrasound, vibration plus suction, electrochromatography, denaturing electrophoresis, SDS electrophoresis, electrophoresis of reduced and denatured analyte, magnetic particle solid phase, local cell or tissue disruption followed by wider-area recovery of molecules, local molecule liberation followed by soaking

### Driving Forces for Effecting Transfer of Analyte Molecules of Interest

Suitably molecules of interest are transferred to one or mote solid phase media under the influence of a temperature or voltage gradient, or under the influence of a liquid flow driven by a pressure difference or by capillarity. Driving forces for effecting transfer of molecules of interest can comprise wicking, diffusion, buoyancy, electrophoresis, dielectrophoresis, pulsed-field electrophoresis, electrochromatography, capillarity, liquid flow, vacuum, pressure, liquid expression, liquid imbibing, centrifugally-driven flow, ultrasound, pressure cooking, weight, pressure, compression, and clamping.

### Solid Phase Contact Medium or Media

Solid phase contact media to which as a receiving material analyte molecules of interest are transferred comprise adsorbents, charged surfaces, non-porous surfaces, suitably ones in which the receiving surface is not penetrated from one face to the other by pores covering more than 2% of its area, and ones in which a receiving surface is separated from the tissue by a liquid or gel. More particularly, solid phase contact media to which molecules of interest are transferred suitably comprise a membrane or membranes, TLC plate, supported membrane, adsorbent, charged surface, affinity adsorbent, immobilized antibody, chelator, metal chelate, iron chelate, chelated copper ion, IMAC media, porous membrane, microporous membrane, supported microporous membrane, nitrocellulose membrane, PNA media, LNA media, reactive surface, self-assembled monolayer, a MEMS device, a “smart polymer” modified surface, a charge-switch surface, acrylamide, butyl acrylamide film, Genvault Gentegra support, polypropylene, polystyrene, hydrophobic adsorbent, an ion-exchanger, zirconia, magnetic particle, nanoparticle, monolith, an adsorbent bearing a phenyl, amine, quaternary amine, DEAE, C18 or other reverse phase group, a chip, plate, disk, a surface comprising PVDF, nitrocellulose, nylon, or charged nylon, a filter paper, an adsorbent supported on porous backing glass, a plastic, polypropylene, polycarbonate, or metal surface, indium tin oxide on glass, a conductor, a semiconductor, gold on silicon, a self-assembled monolayer on gold, a supported particulate, silica, or hydroxyapatite surface, or a TLC plate.

Solid phase media (receiving materials) may comprise multiple types applied sequentially, may move, and may optionally contain human- and/or machine-readable grids or alignment marks. Multiple types or portions of receiving materials may be assembled into a strip or tape, which may optionally be applied to the same source of molecules sequentially. Receiving materials are preferably of high capacity for adsorbing or holding molecules of interest. Different receiving materials may be applied to the same source of diagnostically-informative analytes sequentially, with sectioning and/or surface treatments (heat, cold, enzyme, mechanical force, etc) applied to the source between applications of receiving materials. Receiving materials may hold liquid, which is expressed by pressure, and may be in the form of a roll, strip, array, or deck. Some receiving materials applied to a given source of molecules may be optimized for long-term archival storage, and others optimized for prompt use in diagnosis by in situ assay or recovery of diagnostically-informative molecules.

### Liquid Contact Media

Liquid contact media, as mentioned, include liquids, suspensions, gels and emulsions, dense liquid, heavy water, viscous liquid, flowing liquid, and chemically and/or enzymatically-active liquid, and cryogels, and also include shape supported liquid mediums, for example, a supported gel, and emulsion and supported liquid membranes.

### Separation/Isolation of Analytes in the Identified Area of Interest

After capturing the analytes of interest in the solid phase medium, the analytes in the identified area of interest are separated or isolated from analytes in the remainder of the solid phase medium. Molecules of interest can be detected while still associated with the material to which they are transferred, or recovered from the solid phase medium in whole or in part for detection.

Isolating the analytes in the identified area of interest may comprise physically separating a portion of the solid phase medium from the rest of the solid phase medium, such portion corresponding to the two dimensional spatial locations of the solid phase medium corresponding to the identified locations of the areas of interest in the tissue specimen. Such physical means of separation may be by cutting, pipetting, flow, scraping, vacuum, milling, or brushing.

Isolating the analytes in the identified area of interest may also comprise recovering the analytes from the two dimensional spatial locations of the solid phase medium corresponding to the identified locations of the areas of interest in the tissue specimen by salting, pH change, soluble competitor, imidazole, temperature, diffusion, surfactant, voltage gradient, cutting out, soaking out, blotting, spontaneous desorption over time, PCR cycling, maceration, sonication, or dissolution of solid phase.

Rollers may be used to express liquid from a receiving material.

### Detection of Separated/Isolated Analytes

Detection of isolated analytes is achieved by methods comprising PCR, qPCR, RT-PCR, NASBA, LAMP, RCA, immunoassay, immunoPCR, enzyme activity assay, staining, imaging, WGA, in situ PCR, in situ WGA, polony (polymer colony) formation, sequencing, single-molecule sequencing, nanopore analysis, nanopore sequencing, single-molecule imaging, DNA ball formation, electrophoresis, chromatography, liquid chromatography), gas chromatography, gas chromatography mass spectrometry, mass spectrometry, MEMS aka “lab on a chip,” electrophoresis, mass spectrometry, proximity ligation assay, LC, GC, bioassay, electrochemical detection, plasmon resonance, FRET, electrochemiluminescence ELISA, and chemiluminescence ELISA.

Specimen preparation may include repeated sectioning based on the results of staining, scanning, or imaging, optionally under automatic control.

The following table augments what has already been non-limitingly described, and provides further instructive exemplification of materials and acts comprehended by the invention as claimed.

| Parameter | Example |
|---|---|
| Source material | Fine needle aspiration, excisional biopsy, ultrasound guided needle |
| (Tissue specimen) | biopsy, optoacoustic guided biopsy, IR guided biopsy, endoscopy, |
| | colonoscopy, skin punch, surgically-resected tissue, FFPE block, |
| | frozen specimen, neutral formalin specimen, ethanol-fixed paraffin- |
| | embedded block, block of material pretreated with zinc or inhibitors |
| | of RNAse, DNAse, phosphatase, and/or glycosidase before |
| | embedding, touch print, cells pulled from specimen to an adhesive |
| | surface, tissue in low-melting paraffin |
| Sample of source material | Section, core, extract, macerate, laser capture microdissection |
| (specimen, section or | section, leachate, deparaffinized section, section cut within the past |
| portion) | 2 h, touch print, cells pulled from specimen to an adhesive surface. |
| | Sectioning methods include slicing, planning, laser cutting, and the |
| | use of jets comprising liquids and particulates. |
| Section thickness | 1-400 μm. Sections may be of a broad range of thicknesses, and the |
| | sections taken from the same specimen may be of differing |
| | thicknesses |
| Sample support | Glass, plastic, polypropylene, polycarbonate, metal, indium tin |
| | oxide on glass, conductor, semiconductor, gold on silicon, self- |
| | assembled monolayer on gold, membrane, microporous membrane, |
| | supported microporous membrane, PVDF, ion-exchange cellulose, |
| | Whatman DE81, nitrocellulose, none |
| Sample examination; | Visual, grossing, combined human and machine vision, data fusion, |
| identification | H&E staining, specialized stain, IHC, immunostaining, nanoparticle |
| | adsorption, quantum dot solid phase, enzyme signal, LC, GC, LC- |
| | MS, GC-MS, CAT scan, imaging of calcification, MRI imaging, |
| | ultrasound imaging, mechanical profiling, stiffness profiling, |
| | thermography, acousto-optical imaging, confocal imaging, PET |
| | imaging, SPECT imaging, fluorescence imaging, SEM, TEM, IR |
| | microscopy, data-fusion, automated image analysis, digital |
| | subtraction of pixel intensities in different images, digital ratioing of |
| | pixel intensities in different images, FISH, chromosome painting, |
| | staining for DNA content, surface staining, scanning for statistically |
| | unusual features, automated sectioning to reach a selected depth |
| | chosen based on imaging |
| Sample preparation | Enzyme, nuclease inhibitor, protease, lipase, mixed enzymes, |
| | RNAse, DNAse, nuclease, protease inhibitor, zinc, carbohydrase, |
| | phosphatase inhibitor, deparaffinization, heating, surface heating, |
| | heating by hot liquid applied, heating by chemical reaction, |
| | maceration, scoring, indenting, abrasion, sandblasting, extraction, |
| | sonication, microwave treatment, pH below 5.0, pH above 9.0, |
| | water/organic mixture, DMSO, washing, ultrasound treatment, |
| | leaching, oxidation, reduction, beta-mercaptoethanol, dithiothreitol, |
| | in situ PCR, in situ whole-genome amplification, restriction |
| | endonuclease digestion, ETDA, PMSF, limonene, surfactant, ester |
| | solvent, ester solvent followed by lipase, supercritical fluid solvent, |
| | liquid carbon dioxide solvent, formalin, picric acid, ethanol, |
| | electroporation, blotting at elevated temperature, sponging, |
| | uncovering, sectioning, marking, photographing, scanning, imaging, |
| | and treatment with RNAse, DNAse, protease, phosphatase, and/or |
| | glycosidase inhibitors, autolysis, surface heating, surface freezing, |
| | freeze/thaw cycle, cooling by expanding gas or vapor. |
| Analyte | Genomic DNA, methylated DNA, messenger RNA, fragmented |
| | DNA, fragmented RNA, fragmented mRNA, mitochondrial DNA, |
| | viral RNA, microRNA, in situ PCR product, polyA mRNA, |
| | ribosomal RNA, RNA/DNA hybrid, microbial DNA, virus DNA, |
| | microbial RNA, virus RNA, pathogen nucleic acid, protein, |
| | glycoprotein, lipoprotein, lipid, carbohydrate, phosphoprotein, |
| | specific phosphorylated variant of protein, virus, chromosome, stem |
| | cell marker, tissue-specific marker, cell surface marker |
| Means of analyte recovery | Relative-location-preserving recovery, recovery method with |
| from sample | limited point-spread function width, blotting, electroblotting, |
| | dielectrophoresis, pulsed-field electrophoresis, extraction, wicking, |
| | capillary wicking, liquid expression, diffusion, suction, pipetting, |
| | surfactant extraction, reverse micellar extraction, denaturing |
| | extraction, ultrasound, vibration plus suction, |
| | electrochromatography, denaturing electrophoresis, SDS |
| | electrophoresis, electrophoresis of reduced and denatured analyte, |
| | magnetic particle solid phase, local cell or tissue disruption followed |
| | by wider-area recovery of molecules, local molecule liberation |
| | followed by soaking |
| Surfactant | AOT, CTAB, TOMAC, di-alkyl dimethyl ammonium bromides |
| | where the alkyl chain is 12, 14, 16, or 16 carbons in length, trialkyl |
| | quaternary ammonium chloride, anionic surfactant, mixed |
| | surfactant, neutral surfactant, cationic surfactant, chloride, cationic |
| | lipid |
| Solvent | Isooctane, xylene, limonene, n-decane, cyclohexane, benzene, |
| | toluene, n-hexane, monoaromatics, alkanes, mixed alkanes, melted |
| | paraffin, melted paraffin with surfactant, paraffin containing reverse |
| | micelles and co-solvent, supported solvent, viscous solvent, dense |
| | solvent |
| Surfactant concentration | 1 micromolar to 100 mM |
| Modifiers | Magnesium, spermine, spermidine, n-butanol, 2-butanol, n- |
| | propanol, 1-propanol, pentanol, hexanol, heptanol, octanol, oleyl |
| | alcohol, lauryl alcohol, 2-ethyl-1-hexanol, heavy water |
| Releasing agent | Short-chain alcohol, 1-butanol, 2-butanol, salt, bromides, ethanol, |
| | hexanol, pentanol |
| Temperature for | 0-120° C. |
| Analyte recovery | |
| Contact media including | Membrane or membranes, gel, TLC plate, supported membrane, |
| solid phase medium and | adsorbent, charged surface, affinity adsorbent, immobilized |
| liquid media | antibody, chelator, metal chelate, iron chelate, chelated copper ion, |
| (receiving phase) | IMAC media, porous membrane, microporous membrane, supported |
| for analyte recovered | microporous membrane, nitrocellulose membrane, PNA media, |
| from sample | LNA media, reactive surface, self-assembled monolayer, a MEMS |
| | device, a “smart polymer” modified surface, a charge-switch |
| | surface, acrylamide, butyl acrylamide film, Genvault Gentegra |
| | support, polypropylene, polystyrene, hydrophobic adsorbent, an ion- |
| | exchanger, zirconia, magnetic particle, nanoparticle, monolith, |
| | cryogel, an adsorbent bearing a phenyl, amine, quaternary amine, |
| | DEAE, C18 or other reverse phase group, a chip, plate, disk, or |
| | emulsion, a liquid, supported liquid, or dense liquid, a surface |
| | comprising PVDF, nitrocellulose, nylon, or charged nylon, a filter |
| | paper, an adsorbent supported on porous backing glass, a plastic, |
| | polypropylene, polycarbonate, or metal surface, indium tin oxide on |
| | glass, a conductor, a semiconductor, gold on silicon, a self- |
| | assembled monolayer on gold, a supported particulate, silica, or |
| | hydroxyapatite surface, or a TLC plate, surface with DNA probes, |
| | surface with antibodies, e.g., a polyacrylamide film with |
| | immobilized anti-double-stranded DNA antibodies, surface with |
| | analytical array, surface with cells, surface with fluors, surface with |
| | primers for DNA amplification. |
| Driving force for | Wicking, diffusion, electrophoresis, dielectrophoresis, pulsed-field |
| analyte recovery | electrophoresis, electrochromatography, capillarity, liquid flow, |
| | vacuum, pressure, liquid expression, liquid imbibing, centrifugally- |
| | driven flow, ultrasound, pressure cooking, weight, pressure, |
| | compression, clamping |
| Additional structure | Electrode, blotter, absorbent, support, monolith, pillar array, porous |
| distal or proximal to | support, sieve, microporous support, nanoporous support, frit, |
| receiving phase | sponge, mesh, plate, foam, fiber bed, fabric, non-woven fabric, |
| | conductive layer, self-assembled monolayer, filter paper, reservoir |
| | of releasing agent to destabilize reverse micelles, spacer, film, gel, |
| | liquid layer |
| Metal chelators | Iminodiacetic acid (IDA), Nitrilotriacetic acid (NTA), Pentadentate |
| | chelator (PDC), tris-(2-ethylaminoethyl) amine (TREN), dipicolyl |
| | amine (DPA), chelating lipids |
| Means of recovery of | Salt, pH change, soluble competitor, imidazole, temperature, |
| analyte from solid phase | diffusion, surfactant, voltage gradient, cutting out, soaking out, |
| medium (receiving | blotting, spontaneous desorption over time, PCR cycling, |
| phase) | maceration, sonication, dissolution of solid phase, none |
| Analysis | PCR, qPCR, RT-PCR, NASBA, LAMP, RCA, HCR, immunoassay, |
| | immunoPCR, nanobarcode, enzyme activity assay, staining, |
| | imaging, WGA, in situ PCR, in situ WGA, polony formation, |
| | sequencing, single-molecule sequencing, nanopore analysis, |
| | nanopore sequencing, single-molecule imaging, DNA ball |
| | formation, electrophoresis, MEMS electrophoresis, mass |
| | spectrometry, proximity ligation assay, LC, GC, LC-MS, GC-MS, |
| | electrochemical detection, plasmon resonance, FRET, |
| | electrochemiluminescence ELISA, chemiluminescence ELISA, in |
| | situ staining on receiving surface, in situ PCR, in situ enzymatic |
| | amplification |

Transfer, recovery, and detection are preferably not all applied to the entire specimen or the entire material to which molecules of interest are transferred, but rather to sub-portions chosen based on previous assays, imaging, staining, sorting or inspection.

### EXAMPLES

Exemplary embodiments illustrating application of diagnostics based on direct transfer from a tissue specimen are set forth in Examples 1-8.

### Example 1

### Direct from FFPE Block, Boon, DNA Assay

A 5 μm thick formalin-fixed paraffin-embedded tissue section is examined after H&E staining and regions of diagnostic interest are identified and marked by a pathologist. A digital image showing the regions of diagnostic interest is taken using a digital camera (or other CCD array coupled with a photoelectric device) and digitally stored. The cut surface of the block from which the section was taken is sprayed with guanidine thiocyanate lysis buffer L of Boon et al. (Journal of Clinical Microbiology, March 1990, p. 495-503), and a mechanical device immediately presses against exposed cut block face a sandwich comprising a silica-impregnated membrane, two slices of Whatman 3MM blotting paper, two sheets of Bio-Rad Thick Blot paper, and a polycarbonate backing support. The blotting sandwich is held against the block face for 2 hours, then removed and sent to a second laboratory. The digital image of the stained, pathologist-marked section is electronically transferred to the second laboratory and is used to drive a Techni Techjet X-2 water jet cutter to cut out the spots containing nucleic acids transferred from the regions of interest. DNA from these spots is eluted in low-salt buffer and subjected to next-generation sequencing.

### Example 2

### FFPE Block Multimode Imaging, Multiple Sections, Transfer from Block

A fresh cut tissue specimen is profiled by scanning-inlet GC-MS for the concentrations of metabolic intermediates associated with cancerous tumors, then preserved in the form of an FFPE block. The FFPE block is imaged by X-ray, CAT scan, and MRI, and the resulting images computationally processed to identify likely tumor locations.

The block is robotically sectioned to the appropriate depth to expose candidate tumor locations and then heat-shocked by a flash lamp to make microRNAs easier to recover.

The exposed tissue surface is sprayed with a cationic quaternary ammonium surfactant/isooctane reverse micelle solution and placed in contact an anion-exchange membrane and allowed to transfer for 2 hours. A section of the anion-exchange membrane corresponding to the location of tumor in the original section (as judged by the computational analysis of the imaging results) is robotically spotted with high-salt eluant.

The eluant liquid is recovered after 10 minutes and transferred to a PCR tube for PCR analysis of cancer-associated mutations.

The original block is washed and further sectioned to expose additional likely tumor locations and the recovery and analysis process is repeated for these locations.

### Example 3

### FFPE Block Multimode Imaging, Reverse Micelles, Transfer from Block

An FFPE block is imaged by X-ray, CAT scan, and ultrasound, and the resulting images computationally processed to identify likely tumor locations.

The block is robotically sectioned to the appropriate depth to expose candidate tumor locations and then micro sand-blasted and microwave heated to make DNA easier to recover.

The exposed tissue surface is sprayed with a tetraethyleneglycol dodecyl ether/2,2,4-trimethylpentane reverse micelle solution and placed in contact with an anion-exchange membrane and allowed to transfer for 4 hours. A section of the anion-exchange membrane corresponding to the location of tumor in the original section (as judged by the computational analysis of the imaging results) is robotically spotted with high-salt eluant.

The eluant liquid is recovered after 10 minutes and transferred to a tube for single-molecule sequencing for analysis of cancer-associated mutations.

The original block is washed and further sectioned to expose additional likely tumor locations and the recovery and analysis process is repeated for these locations.

### Example 4

### Multimode Imaging, Reverse Micelles, Protein Transfer from Block

An FFPE block is imaged by X-ray, CAT scanning, OCT, and ultrasound imaging, and the resulting images computationally processed to identify likely tumor locations.

The block is robotically sectioned to the appropriate depth to expose candidate tumor tissue locations and then sonicated to make proteins easier to recover.

The exposed tissue surface is sprayed with an AOT/iso-octane isooctane reverse micelle solution and placed in contact an anion-exchange membrane and proteins allowed to transfer for 2 hours. A section of the anion-exchange membrane corresponding to the location of tumor in the original section (as judged by the computational analysis of the imaging results) is robotically spotted with high-salt eluant.

The eluant liquid is recovered after 10 minutes and transferred to a tube for immuno-PCR analysis of cancer-associated phosphorylation variants.

The original block is washed and further sectioned to expose additional likely tumor locations and the recovery and analysis process is repeated for these locations.

### Example 5

### Multimode Imaging, Redox Reverse Micelles, Protein transfer from Block

An FFPE block is imaged by infrared and ultrasound imaging, and the resulting images computationally processed to identify likely tumor locations.

The block is robotically sectioned to the appropriate depth to expose candidate tumor locations and then sonicated to make proteins easier to recover.

The exposed tissue surface is placed in contact with a porous support impregnated with a reverse micelle solution based on a redox-sensitive surfactant in a solvent and proteins allowed to transfer for 1 hour. A section of the porous support corresponding to the location of tumor in the original section (as judged by the computational analysis of the imaging results) is robotically isolated by applying a circular barrier to compression around it, then the liquid contained in that area is expressed by pressing a porous plunger down onto the isolated region of the support, and the resulting expressed liquid transferred to a sample tube. Beta-mercaptoethanol is added to destroy the reverse micelles and liberate the proteins, the solvent is removed, and the proteins are analyzed for disease biomarkers by electrochemical ELISA.

### Example 6

### Multimode Imaging, FFPE Deparaffination, DNA Transfer from Block

An FFPE tissue block is imaged by X-ray CT scanning, and the results are examined by a pathologist, who designates depth and X-Y coordinates of a region of greatest diagnostic interest. These coordinates are recorded for later use. The depth coordinate is passed to a technician who removes fifteen 5 μm sections by microtome. Next a Whatman 5 MM paper soaked in xylene is placed onto the cut surface of the block and allowed to sit for 4 minutes. The paper is peeled off, and a second Whatman 5MM paper dipped in 100% ethanol is placed on the cut surface of the block and allowed to sit for 5 minutes. The second paper is removed and the block is air dried for 5 minutes at room temperature. Then 120 μL of Qiagen ATL Tissue Lysis Buffer with protease, viscosified by addition of 1% xanthan gum, is pipetted onto the treated cut surface of the block, and allowed to incubate for 60 minutes at 37° C. in a chamber which keeps the humidity above 95%. The X-Y coordinates selected on the basis of the imaging by X-ray are passed to a robotic pipetter which takes up 7 μL of liquid from the location corresponding to the region of interest. The liquid is treated 10 minutes with xanthanase at 30° C., then with trypsin at 56° C. for 1 hour to dissociate tissue fragments, and then at 90° C. for 1 hour to remove cross-linking and denature the protease.

The DNA in the liquid is then purified on a silica DNA-binding column, which is washed twice with AW1 and AW2 solution to remove impurities according to the manufacturer's (Qiagen) instructions. DNA is eluted from the column with the manufacturer's ATE elution buffer, and subjected to PCR using Taq polymerase and Q solution to amplify V-Ki-ras2 Kirsten rat sarcoma viral oncogene homolog sequences.

### Example 7

### Multimode Imaging, FFPE Deparaffination, Protease Buffer Containment, DNA Transfer from Block

The methodology of Example 6 is employed modified in that a means of localizing the 120 μL of Qiagen ATL Tissue Lysis Buffer with protease, viscosified by addition of 1% xanthan gum is employed, selected from a dam, O-ring or gasket, a microchamber, a viscosifier such as sucrose or methylcellulose, hot glue, caulk, or a tissue culture cylinder.

### Example 8

### Multimode Imaging, FFPE Deparaffination, DNA Transfer from Block

The methodology of Example 6 is employed modified in that a membrane is applied to the surface of the tissue block to adsorb the liquid instead of robotically pipetting the liquid, and the DNA is then washed from the membrane, and the wash purified on the silica DNA binding column.

Exemplary embodiments illustrating application of diagnostics based on transfer from a section of a tissue specimen are set forth in Examples 9-17 set forth below.

### Example 9

### FFPE Section Deparaffinization, Boon, DNA Assay

A 5 μm thick formalin-fixed paraffin-embedded tissue section mounted on a glass slide is examined after H&E staining and regions of diagnostic interest are identified by a pathologist. A digital image showing the regions of diagnostic interest of the section is taken using a digital camera (or other CCD array coupled with a photoelectric device), the regions of diagnostic interest are marked on the digital image, and the image is digitally stored.

An adjacent 5 μm section not stained with H&E is mounted on a slide (this is referred to the “section”), deparaffinized in xylene three times for 5 min each (or deparaffinized using alternative reagents), then transferred to sequential baths of 100% ethanol, 95% ethanol, 70% ethanol, and phosphate buffered saline (PBS), for two 5 min treatments in each. The deparaffinized section is soaked for 5 minutes in 1 mM EDTA+40 mM ammonium bicarbonate (pH 8.2), and treated for 45 min with 0.001% trypsin and Protease K in the same buffer at 37° C. for 30 min. The protease-treated section is removed from the protease solution and washed with PBS, and treated with a broad-range cocktail of protease inhibitors in a solution containing EDTA to suppress nuclease action.

The section (slide) is then soaked 15 min in 25 mM Tris, 190 mM glycine (pH not adjusted)+1 mM EDTA in distilled water. A glass slide is covered with two absorbent filter paper pads, and then the tissue section slide, with tissue facing up, is placed on top of the filter paper pads. The tissue is sprayed with guanidine thiocyanate lysis buffer L of Boon et al. (Journal of Clinical Microbiology, March 1990, p. 495-503), and covered with one polycarbonate straight-pore membrane (12220320K08SH02500 GE Polycarbonate PVPF Membrane GE Polycarbonate PVP-Free membrane with 0.8 μm pores), and with a silica-impregnated membrane and then with Whatman 3MM blotting paper, two sheets of Bio-Rad Thick Blot paper, and a glass slide. Before being placed on top of the tissue, all components are pre-wet 5 minutes in 25 mM Tris, 190 mM glycine (pH not adjusted)+1 mM EDTA, and the components are added one layer at a time. The stack is gently rolled with a disposable pipette to eliminate any air bubbles before the top slide is installed. The position of the tissue section slide on the silica membrane is marked for later reference.

The entire stack is heat-sealed into a Kapak polyester pouch (usable to 115° C.). Transfer of nucleic acids from the tissue slice to the solid phase silica membrane is achieved by heating to 65° C. for 5 hours. The stack is disassembled, the silica membrane is washed with Boon's washing buffer L2 made by dissolving 120 g of guanidine thiocyanate in 100 ml of 0.1 M Tris hydrochloride, pH 6.4, and the digital image of the slide is marked by the pathologist to drive a Graphtec FC 2250 cutting plotter to cut out the sections of the silica membrane containing nucleic acids transferred from the regions of interest for DNA analysis.

### Example 10

### FFPE Section Deparaffinization, DEAE Cellulose, DNA Assay

A 5 μm thick formalin-fixed paraffin-embedded tissue section mounted on a glass slide is examined after H&E staining and regions of diagnostic interest are identified by a pathologist. A digital image showing the regions of diagnostic interest of the section is taken using a digital camera (or other CCD array coupled with a photoelectric device), the regions of diagnostic interest are marked on the digital image, and the image is digitally stored.

An adjacent 5 μm section not stained with H&E is mounted on a glass slide and deparaffinized in xylene three times for 5 min each (or deparaffinized using alternative reagents), then transferred to sequential baths of 100% ethanol, 95% ethanol, 70% ethanol, and PBS (two 5 min treatments in each). The deparaffinized section is soaked for 5 minutes in 1 mM EDTA+40 mM ammonium bicarbonate (pH 8.2), and treated for 45 min with 0.001% trypsin and Protease K in the same buffer at 37° C. for 30 min. The protease-treated section is removed from the protease solution and washed with PBS, and treated with a broad-range cocktail of protease inhibitors in a solution containing EDTA to suppress nuclease action.

The slide is then soaked 15 min in 25 mM Tris, 190 mM glycine (pH not adjusted)+1 mM EDTA in distilled water, and installed in a stack of the following components from bottom to top: a glass slide, two absorbent filter paper pads, the tissue section slide, with tissue facing up, one polycarbonate straight-pore membrane (12220320 K08SH02500 GE Polycarbonate PVPF Membrane GE Polycarbonate PVP-Free membrane with 0.8 μm pores), a DEAE derivatized cellulose membrane (see U.S. Pat. No. 5,438,128), and then Whatman 3MM blotting paper, two sheets of Bio-Rad Thick Blot paper, and a glass slide. All components are pre-wet 5 minutes in 25 mM Tris, 190 mM glycine (pH not adjusted)+1 mM EDTA, and the stack assembled one layer at a time. The stack is gently rolled with a disposable pipette to eliminate and air bubbles before the top slide is installed. The position of the slide on the membrane is marked for later reference.

The entire stack is heat-sealed into a Kapak polyester pouch (usable to 115° C.). Transfer of nucleic acids from the tissue slice to the solid phase membrane is achieved by sequential heating to 65° C. for 5 hours, then 75° C. for 30 min, and then at 80° C. for 2 hours. The stack is disassembled, the digital image of the stained section and the registration marks are used to recover the region of interest by cutting the membrane, and KRAS gene sequence DNA is amplified by PCR from this region. The sequence of the amplified DNA is used to guide therapy.

### Example 11

### FFPE Section Deparaffinization, DNA Assay, Anti-dsDNA

A 5 μm thick formalin-fixed paraffin-embedded tissue section mounted on a glass slide is examined after H&E staining and regions of diagnostic interest are identified by a pathologist. A digital image showing the regions of diagnostic interest of the section is taken using a digital camera (or other CCD array coupled with a photoelectric device), the regions of diagnostic interest are marked on the digital image, and the image is digitally stored.

An adjacent 5 μm section not stained with H&E is deparaffinized in xylene three times for 5 min each (or deparaffinized using alternative reagents), then transferred to 100% ethanol, 95% ethanol, 70% ethanol, and PBS (two 5 min treatments in each). The deparaffinized section is soaked for 5 minutes in 1 mM EDTA+40 mM ammonium bicarbonate (pH 8.2), and treated for 45 min with RNAse, 0.001% trypsin and Protease K in the same buffer at 37° C. for 30 min. The protease-treated section is removed from the protease solution and washed with PBS, and treated with a broad-range cocktail of protease inhibitors in a solution containing EDTA to suppress nuclease action.

The slide is then soaked 15 min in 25 mM Tris, 190 mM glycine (pH not adjusted)+1 mM EDTA in distilled water, and installed in a stack of the following components from bottom to top: a glass slide, two absorbent filter paper pads, the tissue section slide, with tissue facing up, one polycarbonate straight-pore membrane (12220320 K08SH02500 GE Polycarbonate PVPF Membrane GE Polycarbonate PVP-Free membrane with 0.8 μm pores), a polyacrylamide film with immobilized anti-double-stranded DNA antibodies, and then Whatman 3MM blotting paper, two sheets of Bio-Rad Thick Blot paper, and a glass slide. All components are pre-wet 5 minutes in 25 mM Tris, 190 mM glycine (pH not adjusted)+1 mM EDTA, and the stack assembled one layer at a time. The stack is gently rolled with a disposable pipette to eliminate and air bubbles before the top slide is installed. The position of the slide on the membrane is marked for later reference.

The entire stack is heat-sealed into a Kapak polyester pouch (usable to 115° C.). Transfer of nucleic acids from the tissue slice to the solid phase membrane is achieved by heating to 65° C. for 8 hours. The stack is disassembled, the digital image of the stained section and the registration marks are used to recover the region of interest by location-selective acid elution of the DNA from the selected region of the membrane, and KRAS gene sequence DNA is amplified by PCR from this eluate. The sequence of the amplified DNA is used to guide therapy.

### Example 12

### FFPE Section Deparaffinization, DEAE Cellulose, RNA Assay

A 5 μm thick formalin-fixed paraffin-embedded tissue section mounted on a glass slide is examined after H&E staining and regions of diagnostic interest are identified by a pathologist. A digital image showing the regions of diagnostic interest of the section is taken using a digital camera (or other CCD array coupled with a photoelectric device), the regions of diagnostic interest are marked on the digital image, and the image is digitally stored.

An adjacent 5 μm section not stained with H&E is deparaffinized in xylene three times for 5 min each (or deparaffinized using alternative reagents), then transferred to 100% ethanol, 95% ethanol, 70% ethanol, and PBS (two 5 min treatments in each). The deparaffinized section is soaked for 5 minutes in 1 mM EDTA+40 mM ammonium bicarbonate (pH 8.2), and treated for 45 min with RNAse-free DNAse, 0.001% trypsin and Protease K in the same buffer at 37° C. for 30 min. The protease- and DNAse-treated section is removed from the protease solution and washed with PBS, and treated with a broad-range cocktail of protease inhibitors in a solution containing EDTA and RNAse inhibitors to suppress nuclease action.

The slide is then soaked 15 min in 25 mM Tris, 190 mM glycine (pH not adjusted)+1 mM EDTA in distilled water, and installed in a stack of the following components from bottom to top: a glass slide, two absorbent filter paper pads, the tissue section slide, with tissue facing up, one polycarbonate straight-pore membrane (12220320 K08SH02500 GE Polycarbonate PVPF Membrane GE Polycarbonate PVP-Free membrane with 0.8 μm pores), a DEAE-derivatized cellulose membrane (see U.S. Pat. No. 5,438,128), and then Whatman 3MM blotting paper, two sheets of Bio-Rad Thick Blot paper, and a glass slide. All components are pre-wet 5 minutes in 25 mM Tris, 190 mM glycine (pH not adjusted)+1 mM EDTA, and the stack assembled one layer at a time. The stack is gently rolled with a disposable pipette to eliminate and air bubbles before the top slide is installed. The position of the slide on the membrane is marked for later reference.

The entire stack is heat-sealed into a Kapak polyester pouch (usable to 115 C). Transfer of nucleic acids from the tissue slice to the solid phase membrane is achieved by sequential heating to 65° C. for 5 hours, then 75° C. for 30 min, and then at 80° C. for 2 hours. The stack is disassembled, the digital image of the stained section and the registration marks are used to recover the region of interest by cutting the membrane, and miRNAs assayed in the material recovered from this region are used for diagnosis and to guide therapy.

### Example 13

### FFPE Deparaffinization, DEAE Cellulose, Electroblotting, RNA Assay

A 5 μm thick formalin-fixed paraffin-embedded tissue section mounted on a glass slide is examined after H&E staining and regions of diagnostic interest are identified by a pathologist. A digital image showing the regions of diagnostic interest of the section is taken using a digital camera (or other CCD array coupled with a photoelectric device), the regions of diagnostic interest are marked on the digital image, and the image is digitally stored.

An adjacent 5 μm section is deposited onto a gold-coated aluminum wafer, not stained with H&E, and is deparaffinized in xylene three times for 5 min each (or deparaffinized using alternative reagents), then transferred to 100% ethanol, 95% ethanol, 70% ethanol, and PBS (two 5 min treatments in each). The deparaffinized section is soaked for 5 minutes in 1 mM EDTA+40 mM ammonium bicarbonate (pH 8.2), and treated for 45 min with RNAse-free DNAse, 0.001% trypsin and Protease K in the same buffer at 37° C. for 30 min. The protease- and DNAse-treated section is removed from the protease solution and washed with PBS, and treated with a broad-range cocktail of protease inhibitors in a solution containing EDTA and RNAse inhibitors to suppress nuclease action.

The slide is then soaked in electroblotting buffer and installed in a stack of the following components from bottom to top: the tissue section slide, with tissue facing up, one polycarbonate straight-pore membrane (12220320K08SH02500 GE Polycarbonate PVPF Membrane GE Polycarbonate PVP-Free membrane with 0.8 μm pores), a DEAE-derivatized cellulose membrane (see U.S. Pat. No. 5,438,128), and then Whatman 3MM blotting paper, and two sheets of Bio-Rad Thick Blot paper. The stack is installed in an electroblotting apparatus and RNA electrophoresed from the tissue onto the DEAE cellulose for 1 hour. The stack is disassembled, the digital image of the stained section and the registration marks are used to recover the region of interest by cutting the membrane, and miRNAs assayed in the material recovered from this region are used to guide therapy.

### Example 14

### FFPE Section, PVDF, Reverse Micelles, Electroblotting, RNA Assay

A slice from an FFPE block is mounted on a gold-coated slide, which is then sandwiched with spacer and PVDF membranes and a final planar electrode. The stack is soaked in AOT/isooctane surfactant to solubilize both paraffin and DNA. Voltage (80V) is applied to electrophorese the nucleic acids toward the PVDF, and the entire stack is heated to 80° C. and held at high temperature under electrophoresis for 6 hours. RNA is recovered from specific locations on the PVDF membrane and subjected to analysis by RT-PCR.

### Example 15

### FFPE Section, PVDF, Reverse Micelles, Heat, RNA Assay

A slice from an FFPE block is mounted on a glass slide, which is then sandwiched on top of non-adsorptive spacer and PVDF membrane and a final glass support. The stack is soaked in AOT/isooctane to solubilize both paraffin and DNA, and the entire stack is heated to 70° C. and held at high temperature for 6 hours. RNA is recovered in a location-specific way from the PVDF membrane and subjected to analysis by RT-PCR.

### Example 16

### FFPE Section, HCl Depurination, Gel, PVDF, DNA Assay

A section from an FFPE block is mounted on a glass slide, sprayed with a mist of 50 mM HCl to depurinate and fragment DNA to make it easier to recover, placed on a spin-coater, spun briefly to displace excess liquid then coated with a thin layer of agarose gel. The gel-coated section is placed against an anion-exchange membrane and allowed to transfer overnight. A section of the anion-exchange membrane corresponding to the location of tumor in the original section (as judged by automated inspection of an adjacent section from the same block) is cut from the membrane by a plotter-cutter and deposited into a PCR tube for PCR analysis of cancer-associated mutations.

### Example 17

### FFPE Section, HCl Depurination, Gel, PVDF, Elution, DNA Assay

A section from an FFPE block is mounted on a glass slide, deparaffinized, heated 2 hrs at 90° C., sprayed with a mist of 50 mM HCl to depurinate and fragment DNA to make it easier to recover, placed on a spin-coater, spun briefly to displace excess liquid then coated with a thin layer of agarose gel. The gel-coated section is placed against an anion-exchange membrane and allowed to transfer overnight. A section of the anion-exchange membrane corresponding to the location of tumor in the original section (as judged by automated inspection of an adjacent section from the same block) is eluted with low ionic strength buffer and the eluate deposited into a PCR tube for PCR analysis of cancer-associated mutations.

### GLOSSARY

The following abbreviations appearing in this specification have the following meanings, as known in the art, included here for the avoidance of doubt.

AOT sodium bis (2-ethylhexyl) sulfosuccinate

CAT computed axial tomography

CCD charge coupled device

cDNA complement DNA

CTAB cetyl trimethyl ammonium bromide

DEAE diethylaminoethyl cellulose

DMSO dimethylsulfoxide

DNA deoxyribonucleic acid

DNAse deoxyribonuclease

DPA dipicolyl amine

EDTA ethylenediaminetetraacetic

ELISA enzyme linked immunosorbent assay

FFPE formalin fixed paraffin embedded

FISH fluorescent in situ hybridization

FRET fluorescence resonance energy transfer

GC gas chromatograph

GC-MS gas chromatography mass spectrometry

H&E haematoxylin and eosin

IDA iminodiacetic acid

IHC immunohistochemistry

IMAC immobilized metal ion affinity chromatography

IR Infra-red

ISH in situ hybridization

KRAS V-Ki-ras2 Kirsten rat sarcoma viral oncogene homolog

LAMP loop mediated isothermal amplification

LC-MS liquid chromatography-mass spectrometry

LCM laser solid phase microdissection

LNA locked nucleic acid

MEMS microelectromechanical system

miRNA micro RNA

MRI magnetic resonance imaging

mRNA messenger RNA

MS mass spectrometry

NASBA nucleic acid sequence based amplification

NTA nitrilotriacetic acid

PBS phosphate buffered saline

PCR polymerase chain reaction

PDC pentadentate chelator

PET positron emission tomography

PMSF phenylmethylsulfonyl fluoride

PNA peptide nucleic acid

polyA Poly adenosine

PVDF polyvinylidene fluoride

qPCR quantitative polymerase chain reaction

RCA rolling circle amplificaiton

RNA ribonucleic acid

RNAse ribonuclease

RT-PCR reverse transcription polymerase chain reaction

SDS sodium dodecyl sulfate

SEM scanning electron microscope

SPECT Single photon emission computed tomagraphy

TLC thin layer chromatography

TEM transmission electron microscopy

TOMAC trioctylmethyl ammonium chloride

TREN tris-(2-ethylaminoethyl)amine

WGA whole genome amplification

### CONVENTIONS AND INTERPRETATION

Specific details described herein, including what is stated in the Abstract, are in every case a non-limiting description and exemplification of embodiments representing concrete ways in which the concepts of the invention may be practiced. This serves to teach one skilled in the art to employ the present invention in virtually any appropriately detailed system, structure or manner consistent with those concepts. Reference throughout this specification to “an exemplary embodiment” means that a particular feature, structure, or characteristic described in connection with the embodiment is included in at least one exemplary embodiment of the present invention. Thus, the appearances of the phrase “in an exemplary embodiment” in various places throughout this specification are not necessarily all referring to the same embodiment. Furthermore, the particular features, structures, or characteristics may be combined in any suitable manner in one or more embodiments. It will be seen that various changes and alternatives to the specific described embodiments and the details of those embodiments may be made within the scope of the invention. It will be appreciated that one or more of the elements depicted in the drawings can also be implemented in a more separated or integrated manner, or even removed or rendered as inoperable in certain cases, as is useful in accordance with a particular application. Because many varying and different embodiments may be made within the scope of the inventive concepts herein described and in the exemplary embodiments herein detailed, it is to be understood that the details herein are to be interpreted as illustrative and not as limiting the invention to that which is illustrated and described herein.

As used herein, the use of the word “a” or “an” when used in conjunction with the term “comprising” (or the synonymous “having”) in the claims and/or the specification may mean “one,” but it is also consistent with the meaning of “one or more,” “at least one,” and “one or more than one.” In addition, as used herein, the phrase “connected to” means joined to or placed into communication with, either directly or through intermediate components.

The above disclosed subject matter is to be considered illustrative, and not restrictive, and the appended claims are intended to cover all modifications, enhancements, and other embodiments that fall within the true scope of the present invention, which to the maximum extent allowed by law, is to be determined by the broadest permissible interpretation of the following claims and their equivalents, unrestricted or limited by the foregoing detailed descriptions of exemplary embodiments of the invention.

1. A method of obtaining for analysis one or more analytes of diagnostic interest from a tissue specimen having an identified area of diagnostic interest in a two-dimensional spatial location, comprising:
a. contacting the identified area of diagnostic interest with a contact medium and effecting at least partial transfer of the one or more analytes from the area of diagnostic interest to the contact medium, and
b. removing the contact medium from the specimen for analysis for the one or more analytes of diagnostic interest.

2. The method of claim 1 in which the analytes of diagnostic interest are one or more of genomic DNA, methylated DNA, specific methylated DNA sequences, messenger RNA, fragmented DNA, fragmented RNA, fragmented mRNA, mitochondrial DNA, viral RNA, microRNA, in situ PCR product, polyA mRNA, RNA/DNA hybrid, lipid, carbohydrate, protein, glycoprotein, lipoprotein, phosphoprotein, specific phosphorylated or acetylated variant of a protein, or viral coat proteins.

3. The method of claim 1 in which the contact medium is a liquid, gel, suspension or emulsion, or a liquid, gel, suspension or emulsion supported by a solid phase.

4. The method of claim 3 further comprising analyzing the liquid, gel, suspension or emulsion for the analyte.

5. The method of claim 1 in which the contact medium is a solid phase medium.

6. The method of claim 5 in which the solid phase medium is contacted with said area of diagnostic interest in a manner to mirror the location of the area on the solid phase medium.

7. The method of claim 6 further comprising transferring the analyte from the solid phase medium into a liquid phase medium and analyzing the liquid phase medium for the analyte.

8. The method of claim 1 further comprising identification of the two-dimensional spatial location of said area of diagnostic interest in the tissue specimen before contacting the tissue specimen with the solid phase medium and effecting transfer of the analyte.

9. The method of claim 8 in which identification comprises at least one of human or machine inspection of the tissue specimen and recordation of the two-dimensional spatial location of said area of diagnostic interest in the tissue specimen.

10. The method of claim 9 in which the recordation comprises an image.

11. The method of claim 10 in which said inspection is human by view by microscope and said recordation comprises making a photographic image of the field of view of the microscope in which the area of diagnostic interest in the tissue specimen is viewed.

12. The method of claim 10 in which the inspection is by machine imaging by one or more of X-ray, infrared, fluorescence, ultrasound, absorbance, scattering, optoacoustic imaging, computed tomography, optical coherence tomography, magnetic resonance imaging, positron emission tomography or single photon emission computed tomagraphy.

13. The method of claim 9 in which both human and machine inspection are conducted and the results of the inspection are combined to define the situs of the area of diagnostic interest in the tissue specimen.

14. The method of claim 13 further comprising removing layers of the tissue specimen to a depth predetermined by definition of the situs to expose the situs.

15. The method of claim 13 comprising removing portions of the tissue specimen by a scanning probe, blade, jet, energy beam, fluid or gas flow, sonicator, or vacuum to expose said situs.

16. The method of claim 12 comprising two or more imaging modalities and in which data results from use of the modalities are combined mathematically to define the situs of the area of diagnostic interest in the tissue specimen.

17. The method of claim 16 further comprising removing layers of the tissue specimen to a depth predetermined by definition of the situs to expose the situs.

18. The method of claim 16 comprising removing portions of the tissue specimen by a scanning probe, blade, jet, energy beam, fluid or gas flow, sonicator, or vacuum to expose said situs.

19. The method of claim 1 in which said tissue specimen is prepared for said contacting with said solid phase medium by acid, enzyme action, heat, surfactant, or disrupting mechanical force.

20. The method of claim 1 in which said tissue specimen comprises fresh tissue, frozen tissue, neutral formalin-treated tissue, formalin fixed paraffin embedded tissue block, and ethanol-fixed paraffin-embedded tissue block.

21. The method of claim 20 in which the tissue specimen is a formalin fixed paraffin embedded block and in which the block is prepared for said contacting by aromatic solvent dissolution of paraffin on the surface of the block and aliphatic solvent removal of the aromatic solvent from the surface.

22. The method of claim 21 in which said tissue specimen is next prepared for said contacting with said contact medium by acid, enzyme action, heat, surfactant, or disrupting mechanical force.

23. The method of claim 5 in which the solid phase medium is a single membrane.

24. The method of claim 5 in which the solid phase medium is separated from the tissue specimen by a liquid or gel.

25. The method of claim 5 in which the solid phase medium comprises an adsorbent.

26. The method of claim 5 in which the solid phase medium comprises a charged surface.

27. The method of claim 5 in which the solid phase medium is non-porous.

28. The method of claim 5 in which the solid phase medium is not penetrated from one face to the other by pores covering more than 2% of its area.

29. The method of claim 5 in which the solid phase medium comprises a marked dimension by which coordinates of an area of interest can be described.

30. The method of claim 29 in which the solid phase medium is formatted as a grid.

31. The method of claim 5 in which the solid phase medium comprises more than one composition, and further comprising sequentially contacting the tissue specimen area of diagnostic interest with said solid phase medium of more than one composition.

32. The method of claim 31 comprising:
(a) moving a first surface of a solid phase medium into opposition with a surface of the tissue specimen area of diagnostic interest,
(b) moving said first surface into contact with said surface of the tissue specimen,
(c) effecting said transfer,
(d) moving said first surface away from the tissue specimen,
(e) positioning a second surface of the solid phase medium opposite said surface of the tissue specimen area, and
(f) repeating acts (b)-(d) for said second surface.

33. The method of claim 32 in which the second surface comprises a composition different from said first surface.

34. The method of claim 31 in which the solid phase medium has the form of a roll, deck or strip.

35. The method of claim 5 in which analytes of interest are transferred under the influence of a temperature or voltage gradient.

36. The method of claim 5 in which analytes of interest are transferred under the influence of a liquid flow driven by a pressure difference, suction, chemical activity difference, or by capillarity action.

37. A method of obtaining one or more analytes of diagnostic interest from a tissue specimen for analysis, comprising
(a) slicing a tissue section from a tissue specimen,
(b) identifying the spatial location(s) of one or more areas of diagnostic interest in the tissue section, and
(c) contacting the tissue specimen with a solid phase medium and effecting transfer of one or more analytes from the one or more areas of diagnostic interest in the tissue specimen to the solid phase medium in a manner that places the analytes at the same two dimensional spatial locations of the solid phase medium as the locations of the areas of interest in the tissue specimen identified in the tissue section.

38. The method of claim 37 further comprising, after act (b) and before act (c) of claim 37, preparing the tissue specimen for analyte transfer.

39. The method of claim 38 in which the act of preparing comprises at least one of treating the tissue specimen with acid, enzyme action, heat, surfactant, or disrupting mechanical force.

40. The method of claim 37 further comprising identifying the one or more areas of interest of the solid phase medium by reference to the record of locations made in act (b) of claim 37.

41. The method of claim 40 further comprising separating one or more identified areas of interest of the solid phase medium from other areas of interest of the solid phase medium.

42. The method of claim 41 further comprising recovering one or more analytes of interest from the separated areas of interest of the solid phase medium in a recovery medium, and analyzing the recovery medium for the one or more analytes of interest.

43. A method of obtaining one or more analytes of diagnostic interest from a tissue specimen for analysis, comprising
(a) slicing a first tissue section from a tissue specimen
(b) recording the spatial location(s) of one or more areas of diagnostic interest in the first tissue section
(c) slicing a second tissue section from the tissue specimen in a manner to preserve in the second section generally the same spatial location(s) of the areas of interest recorded for the first tissue section, and
(d) contacting the second tissue section with a solid phase medium and effecting transfer of one or more analytes from the one or more areas of diagnostic interest to the solid phase medium in a manner that places the analytes in or on the solid phase medium at the same two dimensional spatial locations as the locations of the areas of interest in the second tissue section.

44. The method of claim 43 further comprising, after act (b) and before act (c), preparing the tissue section for analyte transfer.

45. The method of claim 44 in which the act of preparing comprises at least one of treating the tissue specimen with acid, enzyme action, heat, surfactant, or disrupting mechanical force.

46. The method of claim 43 further comprising separating one or more identified areas of interest of the solid phase medium from other areas of interest of the solid phase medium.

47. The method of claim 46 further comprising recovering one or more analytes of interest from the separated areas of interest of the solid phase medium in a recovery medium, and analyzing the recovery medium for the one or more analytes of interest.

48. A method of detecting one or more analytes of diagnostic interest from a tissue specimen, comprising:
(a) receiving a solid phase medium containing one or more of the analytes in a two dimensional spatial area mirroring a two-dimensional spatial area of interest in the tissue specimen from which the one or more analytes were transferred,
(b) identifying the location of the two dimensional spatial area of interest of the solid phase medium,
(c) separating the one or more analytes in the area of interest of the solid phase medium from the medium into a liquid, and
(d) analyzing the liquid for the one or more analytes.

49. The method of claim 48 further comprising isolating the analytes in the solid phase medium in said identified area of interest from analytes in the remainder of the solid phase medium prior to act (c) of claim 48.

50. The method of claim 49 in which said step of isolating comprises physically separating a portion of the solid phase medium from the rest of the solid phase medium, said portion corresponding to the two dimensional spatial locations of the solid phase medium corresponding to the documented locations of the areas of interest in the tissue specimen.

51. The method of claim 49 in which the step of isolating comprises eluting the two dimensional spatial locations of the solid phase medium corresponding to the documented locations of the areas of interest in the tissue specimen.

52. The method of claim 48 in which the method of analyzing comprises one or more of PCR, qPCR, RT-PCR, NASBA, LAMP, RCA, immunoassay, immunoPCR, enzyme activity assay, staining, imaging, WGA, in situ PCR, in situ WGA, polony formation, sequencing, single-molecule sequencing, nanopore analysis, nanopore sequencing, single-molecule imaging, DNA ball formation, electrophoresis, MEMS electrophoresis, mass spectrometry, proximity ligation assay, electrochemical detection, plasmon resonance, FRET, electrochemiluminescence ELISA, and chemiluminescence ELISA
